(19) United States
(12) Patent Application Publication
(10) Pub. No.: US 2013/0050094 A1
(43) Pub. Date: Feb. 28, 2013

(54) METHOD AND APPARATUS FOR PREVENTING MALFUNCTION OF TOUCHPAD IN ELECTRONIC DEVICE

(71) Applicants: Jong-Hun RHEE, Suwon-si (KR); Hun-Kee KIM, Seoul (KR)

(72) Inventors: Jong-Hun RHEE, Suwon-si (KR); Hun-Kee KIM, Seoul (KR)

(73) Assignee: SAMSUNG ELECTRONICS CO. LTD., Suwon-si (KR)

(21) Appl. No.: 13/595,301

(22) Filed: Aug. 27, 2012

(30) Foreign Application Priority Data
Aug. 29, 2011 (KR) 10-2011-0086488

(51) Int. Cl. G06F 3/041; G06F 3/02

(52) U.S. Cl. 345/168

(57) ABSTRACT

A method and an apparatus for preventing a malfunction of a touchpad in an electronic device are provided. The method includes determining whether one or more input signals is continuously received due to one or more keys of a key input unit being continuously depressed, and controlling an activation state of the touchpad according to the determination result.

### PRIORITY

This application claims the benefit under 35 U.S.C. §119(a) of a Korean patent application filed on Aug. 29, 2011 in the Korean Intellectual Property Office and assigned Serial No. 10-2011-0086488, the entire disclosure of which is hereby incorporated by reference.

### BACKGROUND OF THE INVENTION

1. Field of the Invention

The present invention relates to an electronic device. More particularly, the present invention relates to a method and an apparatus for preventing a malfunction of a touchpad.

2. Description of the Related Art

Recently, due to the development of electronic technology, various electronic devices, such as a desk Personal Computer (PC), a note PC, a tablet PC, a mobile phone, a Motion Picture Expert Group (MPEG)-1 or MPEG-2 Audio Layer-3 (MP3) player, and the like, are provided, and continued research is conducted on their functionality to increase their convenience to users.

More particularly, continued research is conducted on an input unit of an electronic device, such as a mouse, a keyboard, a keypad, a touchpad, and the like. For example, continued research is conducted on methods for increasing the portability of the electronic device by reducing a size of the input unit, and for efficiently inputting characters in performing various operations, such as word processing, messaging, e-mailing, and the like, through the input unit.

Among the electronic devices, the note PC has a touchpad and a keyboard as the input unit. The note PC inputs characters through the keyboard and detects a touch of a user through the touchpad to perform a mouse function of the related art. Most note PCs of the related art have the touchpad under the keyboard. While the note PC is turned on, the touchpad is always activated to detect a touch of a user. Accordingly, the note PC may malfunction when the user unintentionally touches the touchpad during the keyboard input. For example, the user may unintentionally touch the touchpad under the keyboard with his/her wrist or palm while inputting characters on a word processing window through the keyboard. In this case, the note PC deactivates the word processing window, interrupts the character input, and performs a function corresponding to a region touched with the wrist or palm. Therefore, the characters submitted by the user through the keyboard may fail to be normally provided on the word processing window.

Therefore, a need exits for a method and an apparatus for preventing a malfunction of a touchpad.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for preventing a malfunction of a touchpad in an electronic device.

Another aspect of the present invention is to provide a method and an apparatus for deactivating a touchpad in an electronic device during a continuous depression of one or more keys of a key input unit.

Another aspect of the present invention is to provide a method and an apparatus for controlling an activation state of a touchpad in an electronic device by determining whether one or more keys of a key input unit are depressed within a predefined time.

In accordance with an aspect of the present invention, a method for preventing a malfunction of a touchpad in an electronic device is provided. The method includes determining whether one or more input signals is continuously received due to one or more keys of a key input unit being continuously depressed, and controlling an activation state of the touchpad according to the determination result.

In accordance with another aspect of the present invention, an apparatus for preventing a malfunction of a touchpad in an electronic device is provided. The apparatus includes a touchpad configured to detect a touch of a user, a key input unit including one or more keys, and a control unit configured to determine whether one or more input signals is continuously received due to the one or more keys of the key input unit being continuously depressed, and to control an activation state of the touchpad according to the determination result.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description when taken in conjunction with the accompanying drawings in which:

FIG. 1 is a block diagram illustrating a configuration of an electronic device according to an exemplary embodiment of the present invention; and

FIG. 2 is a flowchart illustrating an operation for preventing a malfunction of a touchpad in an electronic device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, a method and an apparatus for preventing a malfunction of a touchpad in an electronic device according to exemplary embodiments of the present invention will be described. In the following description, an electronic device may be any device that includes a key input unit including one or more keys and a touchpad for detecting a touch of a user. For example, the electronic device may be a note Personal Computer (PC) including a touchpad and a keyboard, or a portable terminal including a touchpad and a keypad. Thus, although the keyboard is exemplified as the key input unit, exemplary embodiments of the present invention may also be similarly applied to the keypad.

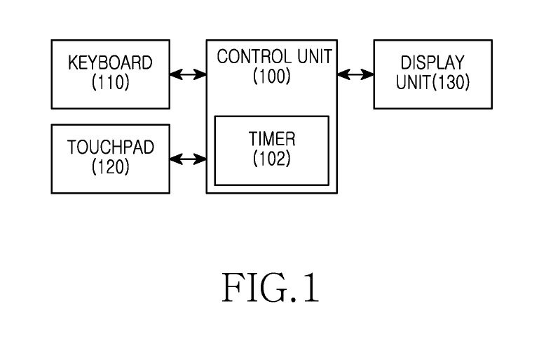

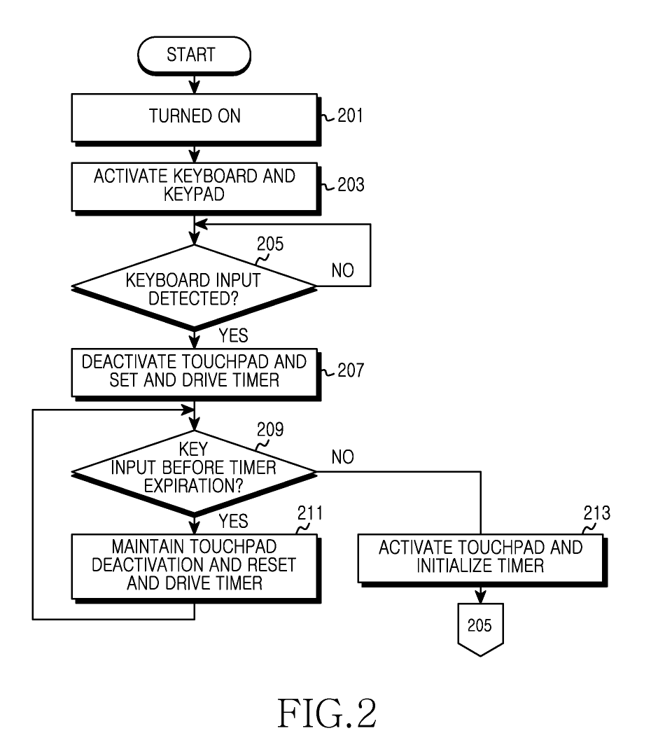

FIGS. 1 and 2, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating a configuration of an electronic device according to an exemplary embodiment of the present invention.

Referring to FIG. 1, the electronic device may include a control unit 100, a keyboard 110, a touchpad 120, and a display unit 130. The control unit 100 may include a timer 102.

The control unit 100 is configured to control and process an overall operation of the electronic device. The control unit 100 controls and processes an operation for detecting a user input through the touchpad 120 and performing a function corresponding to the user input. More particularly, the control unit 100 controls and processes an operation for detecting a continuous depression of one or more keys of the keyboard 110 through the timer 102 and deactivating the touchpad 120 during the continuous key depression.

Specifically, when the electronic device is turned on, the control unit 100 activates the keyboard 110 and the touchpad 120 and detects whether one or more input signals are received due to a depression of one or more keys of the keyboard 110. When an input signal indicating a depression of one or more keys of the keyboard 110 is received, the control unit 100 deactivates the touchpad 120, sets a driving time of the timer 102 to a predefined time, and drives the timer 102. Herein, when an input signal indicating a depression of one or more keys of the keyboard 110 is received, the control unit 100 controls an operation for displaying a numeral or character corresponding to the depression of the one or more keys on the display unit 130 or performing a function corresponding to the depression of the one or more keys. Thereafter, the control unit 100 determines whether an input signal indicating a depression of one or more keys of the keyboard 110 is received before the expiration of the timer 102. When an input signal indicating a depression of one or more keys of the keyboard 110 is received before the expiration of the timer 102, the control unit 100 determines that a user continuously depresses one or more keys, maintains the deactivation state of the touchpad 120, resets a driving time of the timer 102, and drives the timer 102. On the other hand, when an input signal indicating a depression of one or more keys of the keyboard 110 is not received before the expiration of the timer 102, that is, when one or more keys of the keyboard 110 is not depressed until the expiration of the timer 102, the control unit 100 activates the touchpad 120 and maintains the initial state of the timer 102.

That is, through the above operation, the control unit 100 deactivates the touchpad 120 when one or more keys of the keyboard 110 is continuously depressed, and activates the touchpad 120 when one or more keys of the keyboard 110 is not continuously depressed. Accordingly, the generation of an unintentional input through the touchpad 120 can be prevented while one or more keys is continuously depressed by the user, and a desired function can be performed by a touch to the touchpad 120 when a specific key is depressed by the user.

The timer 102 measures a driving time set by the control unit 100, and stops operating upon expiration of the driving time. The driving time of the timer 102 may be set by default based on a key depression speed of a plurality of users, or may be set based on a key depression speed of the user of the electronic device. For example, the control unit 100 may request the user to input a predefined string or word. When keys corresponding to the predefined string or word are depressed on the keyboard 110 by the user, the control unit 100 may measure a key depression speed of all the keys or a time interval between the depression of one key and the depression of the next key to set the driving time of the timer 102. In addition, the driving time of the timer 102 may be directly set and changed by the user.

The keyboard 110 may include one or more function keys, and may provide the control unit 100 with data corresponding to the key depressed by the user. In addition, the keyboard 110 provides the control unit 100 with a signal indicating the depression of a key at the time when the user depresses the key, and provides the control unit 100 with a signal indicating the end of the key depression at the time when the user releases the key or removes his/her finger from the key.

The touchpad 120 includes a touch sensor, detects a touch of the user, and provides the control unit 100 with coordinate data corresponding to a position of the touch of the user. In addition, the touchpad 120 maintains or changes to an activation state or a deactivation state under the control of the control unit 100. Specifically, while the user continuously depresses keys, the touchpad 120 is deactivated under the control of the control unit 100 and does not perform a user touch detection function. On the other hand, while the user does not continuously depress keys, or while the user continuously maintains depression of one key, the touchpad 120 is activated under the control unit 100, detects a touch of the user, and provides the control unit 100 with data corresponding to a position of the touch. Herein, the touchpad 120 may be disposed at a position adjacent to any one of the top, bottom, left and right sides of the keyboard 110.

The display unit 130 displays a variety of status information, numerals, characters, and images that are generated during the operation of the electronic device. In addition, under the control of the control unit 100, the display unit 130 may display a character entered through a key depression of the keyboard 110, and may display a screen indicating a function generated through a depression of a key of the keyboard 110 or a touch to the touchpad 120. In addition, while the touchpad 120 is deactivated, the display unit 130 may display a message indicating the deactivation state of the touchpad 120 on a predefined region of the screen.

The method described above with respect to FIG. 1 of the present invention may be provided as one or more instructions in one or more software modules stored in the respective electronic device.

FIG. 2 is a flowchart illustrating an operation for preventing a malfunction of a touchpad in an electronic device according to an exemplary embodiment of the present invention.

Referring to FIG. 2, the electronic device is turned on in step 201, and the electronic device activates the keyboard 110 and touchpad 120 in step 203.

In step 205, the electronic device detects whether one or more input signals is generated due to a depression of one or more keys of the keyboard 110. Specifically, the electronic device detects whether a key of the keyboard 110 is depressed by the user.

When one or more input signals is generated through the keyboard 110, the electronic device proceeds to step 207. In step 207, the electronic device deactivates the touchpad 120, stops a user touch detection operation, sets a driving time of the timer 102, and drives the timer 102. Herein, the driving time of the timer 102 may be set by default based on a key depression time interval or a key depression speed of a plurality of users, or may be set based on a key depression speed of the user of the electronic device. For example, the electronic device may request the user to input a predefined string or word. When keys corresponding to the predefined string or word are depressed on the keyboard 110 by the user, the electronic device may measure a depression speed of all the keys or a time interval between the depression of one key and the depression of the next key to set the driving time of the timer 102. In addition, the driving time of the timer 102 may be directly set and changed by the user.

Thereafter, in step 209, the electronic device detects whether a key of the keyboard 110 is depressed before the expiration of the driving time of the timer 102. When a key of the keyboard 110 is depressed before the expiration of the driving time of the timer 102, the electronic device determines that keys are continuously depressed by the user, and proceeds to step 211. In step 211, the electronic device maintains the deactivation state of the touchpad 120, resets a driving time of the timer 102, and drives the timer 102 again. Thereafter, the electronic device returns to step 209.

On the other hand, when one or more keys of the keyboard 110 is not depressed before the expiration of the driving time of the timer 102, that is, when an additional input signal is not generated between the start of the driving of the timer 102 and the expiration of the driving time of the timer 102, the electronic device determines that the one or more keys is not continuously depressed by the user, and proceeds to step 213. In step 213, the electronic device activates the touchpad 120 and maintains the initial state of the timer 102. Herein, the case where the user does not continuously depress keys includes the case where the user depresses at least one key for a predefined time. Thereafter, the electronic device returns to step 205.

In the above description, an operation of the electronic device for detecting a continuous key depression through the keyboard and controlling an activation state of the touchpad (hereinafter referred to as a touchpad activation control operation) may not be performed according to a control of the user of the electronic device. For example, an exemplary embodiment of the present invention may provide a menu or a function key for turning on/off the touchpad activation control operation, so that the touchpad may not be deactivated even when keys are continuously depressed by the user, if the user does not want to deactivate the touchpad.

As described above, an exemplary embodiment of the present invention controls an activation state of the touchpad in the electronic device by determining whether a key is depressed within a predefined time from a key depression time point. Therefore, when the user unintentionally touches the touchpad while depressing one or more keys continuously, a malfunction of the touchpad by detection of the unintentional touch can be prevented. Accordingly, the user's satisfaction for the input can be increased.

Exemplary embodiments of the present invention may be realized in the form of hardware, software, or a combination of hardware and software. The software may be stored in a volatile storage medium or a nonvolatile storage medium. Examples of the storage medium include a storage device, such as a Read Only Memory (ROM), a memory device, such as a Random Access Memory (RAM), a memory chip, or an Integrated Circuit (IC), and an optical or a magnetic recording medium, such as a Compact Disk (CD), a Digital Versatile Disk (DVD), a magnetic disk, a magnetic tape, and the like. The storage device or the storage medium is a machine-readable storage unit that is suitable for storing programs including instructions for implementing exemplary embodiments of the present invention. Thus, the exemplary embodiments of the present invention provide programs including codes for implementing the apparatuses and methods of the appended claims. In addition, the programs may be distributed through a wireless or wired communication network, and may be stored and executed in a distributed manner.

Throughout the specification and claims, the terms “comprise”, “include” and “have” and derivatives thereof mean “including but not limited to”, and they do not preclude the addition of one or more other configurations, structures, elements, components, steps, or operations.

Throughout the specification and claims, the singular encompasses the plural unless otherwise specified. More particularly, when the indefinite article is used, it is to be understood as contemplating plurality as well as singularity, unless otherwise specified.

Features, integers, characteristics, and groups described in conjunction with an exemplary embodiment of the present invention may also be applicable to any other exemplary embodiments of the present invention, unless incompatible therewith.

Throughout the specification and claims, language in the general form of “X for Y” (e.g., where Y is an action, an operation, or a step and X is a unit for carrying out the action, the operation, or the step) encompasses a unit X adapted or arranged specifically, but not exclusively, to do Y.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for preventing a malfunction of a touchpad in an electronic device, the method comprising:
determining whether one or more input signals is continuously received due to one or more keys of a key input unit being continuously depressed; and
controlling an activation state of the touchpad according to the determination result.

2. The method of claim 1, wherein the controlling of the activation state of the touchpad according to the determination result comprises deactivating the touchpad while the one or more keys of the key input unit is being continuously depressed.

3. The method of claim 1, wherein the controlling of the activation state of the touchpad according to the determination result comprises activating the touchpad while the one or more keys of the key input unit is not being continuously depressed.

4. The method of claim 1, wherein the determining of whether the one or more input signals is continuously received due to the one or more keys of the key input unit being continuously depressed comprises:
detecting that a first key is depressed through the key input unit;
detecting whether a second key is depressed within a predefined time from a time point of detecting the depression of the first key; and
determining that input signals are continuously received, when the second key is depressed within the predefined time from the time point of detecting the depression of the first key.

5. The method of claim 4, further comprising determining that input signals are not continuously received, when the second key is not depressed within the predefined time from the time point of detecting the depression of the first key.

6. The method of claim 4, further comprising determining that input signals are not continuously received, when the second key is not depressed within the predefined time from the time point of detecting the depression of the first key, wherein the first key is continuously depressed.

7. The method of claim 4, wherein the predefined time is set based on a key depression speed of a user.

8. The method of claim 4, wherein the predefined time is set by default based on a key depression speed of a plurality of users.

9. The method of claim 4, wherein the predefined time is set by measuring a key depression speed of all the keys or a time interval between the depression of the first key and the depression of the second key.

10. An apparatus for preventing a malfunction of a touchpad in an electronic device, the apparatus comprising:
a touchpad configured to detect a touch of a user;
a key input unit including one or more keys; and
a control unit configured to determine whether one or more input signals is continuously received due to the one or more keys of the key input unit being continuously depressed, and to control an activation state of the touchpad according to the determination result.

11. The apparatus of claim 10, wherein the control unit deactivates the touchpad while the one or more input signals is continuously received due to the one or more keys of the key input unit being continuously depressed.

12. The apparatus of claim 10, wherein the control unit activates the touchpad while the one or more input signals is not continuously received due to the one or more keys of the key input unit not being continuously depressed.

13. The apparatus of claim 10, wherein the control unit detects that a first key is depressed through the key input unit, detects whether a second key is depressed within a predefined time from a time point of detecting the depression of the first key, and determines that the first key and the second key are depressed continuously when the second key is depressed within the predefined time from the time point of detecting the depression of the first key.

14. The apparatus of claim 13, wherein the control unit determines that the first key and the second key are not depressed continuously when the second key is not depressed within the predefined time from the time point of detecting the depression of the first key.

15. The apparatus of claim 13, wherein the control unit determines that the first key and the second key are not depressed continuously when the second key is not depressed within the predefined time from the time point of detecting the depression of the first key, wherein the first key is continuously depressed.

16. The apparatus of claim 13, wherein the predefined time is set based on a key depression speed of the user.

17. The apparatus of claim 13, wherein the predefined time is set by default based on a key depression speed of a plurality of users.

18. The apparatus of claim 13, wherein the predefined time is set by measuring a key depression speed of all the keys or a time interval between the depression of the first key and the depression of the second key.

19. A non-transitive computer-readable storage medium configured to store one or more programs including instructions for instructing, when executed by an electronic device, the apparatus to perform the method of claim 1.
